(19) United States
(12) Patent Application Publication
(10) Pub. No.: US 2012/0101837 A1
(43) Pub. Date: Apr. 26, 2012

(54) SYSTEMS AND METHODS FOR MANAGING CLINICAL TRIAL SITE VISIT REPORTS

(76) Inventors: Rae Ellen McCorkle, Clayton, NC (US); Dawn Michelle Anderson, Raleigh, NC (US); Helen Mary Lingard, Cary, NC (US); Mary Margaret Barbour, Garner, NC (US)

(21) Appl. No.: 12/908,501

(22) Filed: Oct. 20, 2010

(51) Int. Cl. G06Q 10/00; G06Q 50/00

(52) U.S. Cl. 705/2

(57) ABSTRACT

Systems and methods are disclosed for managing site visit report creation. Data relationships and process flow rules can be utilized to output reminder messages regarding deadlines associated with a site visit report completion and determine and present proper questions to associates to elicit relevant information about a site visit. Site visit reports can be generated in an efficient and accurate manner and submitted quickly to a sponsor.

### FIELD

This disclosure relates generally to computer software for clinical trial management that runs, displays, provides, or otherwise uses electronic content and more particularly (although not necessarily exclusively) to computer software for managing the generation, tracking, storage, and approval of site visit reports associated with clinical trials.

### BACKGROUND

Clinical trials are conducted to allow safety and efficacy data to be collected for health interventions such as drugs, diagnostics, devices and therapy protocols. These trials take place only after satisfactory information has been gathered on the quality of non-clinical safety, and regulatory authority and ethics committee approval is granted in the country where the trial is taking place.

Depending on the type of product and the stage of development, investigators enroll volunteers into small “Phase I” studies initially, followed by larger scale studies in patients that sometimes compare the new product with currently prescribed treatment. Investigators include physicians in private practice at various research facilities that participate in these studies. As safety and efficacy data are gathered, the number of patients is typically increased. Clinical trials can range in size from a single center in one country to multi-center trials in multiple countries.

A clinical trial is managed by the sponsor (the entity paying for the clinical trial) or a clinical research organization (CRO) that has specific clinical trial expertise and resources capable of being used to manage the clinical trial efficiently and properly. Managing a clinical trial includes conducting visits to sites that are participating in the clinical trial. A “site visit” can be performed by a clinical research associate (CRA) or other associate that is tasked with being a resource to sites and assisting in managing the sites for the responsible entity.

A site visit can include a CRA traveling to the site and performing a clinical trial management function, such as (i) analyzing the site (including practices, policies, staff, equipment, location, etc.) to determine whether to select the site to participate in a clinical trial; (ii) assisting the investigator and staff at the site in identifying and recruiting patients for the clinical trial and otherwise assist the site in preparing to conduct its activities in accordance with the clinical trial protocol; (iii) confirming that the site is operating in accordance with policies and procedures in conducting its activities for the clinical trial; (iv) obtaining clinical trial data from the site; and (v) assisting the site in ending its participation in the clinical trial.

After completing a site visit, the CRA generates a site visit report about the site visit. The site visit report is submitted to a reviewer to confirm that the site visit report is complete and clear, and to identify any issues for follow-up. The reviewer may submit questions to the CRA about an item that needs further clarification, or may approve the site visit report. Approved site visit reports are provided to the sponsor and stored for later access.

Completing a site visit report, even electronically, can be laborious. Site visit reports may include open-ended requests for which the CRA must determine the appropriate amount of information to include in the report to satisfy. Other site visit reports may include many items requiring the CRA to determine the relevance of each item to the particular site visit. Furthermore, site visit reports can reference associated documents, and retaining the relationship between the site visit report and the associated documents can be difficult. Communication between a CRA and reviewer (e.g. via e-mail, facsimile, etc.) can also be inefficient and unsecure, as can management of various deadlines associated with the site visits for which a CRA is responsible.

Accordingly, systems and methods are desirable that can facilitate efficient site visit report creation, tracking, approval processing, and organization.

### SUMMARY

Systems and methods are disclosed for managing site visit reports. One aspect is a clinical trial site visit management system that includes a database and a processor. The database includes questions associated with identifiers of report types for site visits that are conducted to manage clinical trials. The processor can execute code embodied on a non-transitory computer-readable medium to cause the clinical trial site visit management system to perform various processes. The processes can include:

responsive to receiving input representing that a site visit has been completed, determine at least one deadline for completing a site visit report for the site visit;

output a notification to an associate regarding the at least one deadline;

responsive to receiving an identifier of a report type for the site visit report, determine at least one question of the plurality of questions that is associated with the identifier and configure a user interface to include the at least one question; and

responsive to receiving an approval for the site visit report, provide the site visit report to a document management system.

A feature can include the processor storing a link to the site visit report that is in the document management system.

A feature can include the processor associating at least one document with the site visit report.

Another feature can include the site visit report including electronic signatures of the associate and a reviewer.

Another feature can include the processor, responsive to receiving a specified response to the at least one question, configuring the user interface to prohibit receiving a response to a subsequent question to the at least one question.

Another feature can include the database having process rules associated with the identifiers of report types for site visits.

Another feature can include the processor being configure to, responsive to receiving a command to submit the site visit report to a reviewer, confirming that at least one of (i) the site visit report or (ii) steps for completing the site visit report, comply with a process rule associated with the identifier of the report type for the site visit report.

Another feature can include processor being configured to:

analyze a response to the at least one question to determine additional information is desirable; and

generate at least one additional question based on the response to seek the additional information.

Another feature can include processor being configured to generate an audit trail for the site visit report.

Another feature can include the processor being configured to output a message to a sponsor of the clinical trial, where the message includes the link to the site visit report.

Another feature can include the processor being configured to receive a schedule for the site visit prior to the site visit occurring and to output a message to the associate after the site visit was scheduled to occur, the message comprising a reminder for the associate to complete the site visit report.

Another feature can include the processor, responsive to receiving the approval for the site visit report, being configured to:

create a portable document file (PDF) of the site visit report using a Japanese format template if a protocol associated with the site visit report is flagged; and

create the PDF of the site visit report using an English format template if the protocol associated with the site visit report is unflagged.

Another feature can include the processor being configured to receive additional questions from a reviewer and configure the user interface to present the additional questions to the associate.

Another feature can include the database being a Siebel customer relationship management (CRM) database and the processor includes a database server software application.

Another feature can include the at least one deadline includes a first deadline for completing a draft of the site visit report and a second deadline for completing a final version of the site visit report.

Another feature can include the report types being a site selection visit (SSV) report, a site initiation visit (SIV) report, a site monitoring visit (SMV) report, and a site closeout visit (COV) report.

Another feature can include the clinical trial site visit management system including the document management system and the document management system being capable of creating a file comprising the site visit report and at least one document (e.g. collateral) associated with the site visit report.

Another feature can include the database including the document management system.

Another aspect is a computer-implemented method for managing a clinical trial that includes the following:

receiving input representing that a site visit has been completed and an identifier of a report type for the site visit report;

determining, by a computing device, at least one deadline for completing the site visit report for the site visit based on a completion date of the site visit and output a notification to an associate about the deadline;

determining, by the computing device, at least one question of a plurality of questions that is associated with the identifier and configure a user interface to include the at least one question; and

in response to receiving an approval of the site visit report, providing the site visit report to a sponsor.

Another feature is the following:

in response to receiving the approval of the site visit report,

creating a portable document file (PDF) comprising the site visit report and a collateral document;

providing the PDF file to a document management system for storage; and

storing a link to the PDF file stored in the document management system.

Another feature is the following:

analyzing an answer to the at least one question and determining a subsequent question to present on the user interface based on the answer; and

confirming that at least one of (i) the site visit report or (ii) steps for completing the site visit report, comply with a process rule associated with the identifier of the report type for the site visit report.

Another feature can include outputting the notification to the associate about the at least one deadline comprising outputting the notification after determining a task associated with the deadline has not been completed.

Another aspect is a non-transitory computer-readable medium tangibly embodying executing code for managing a clinical trial. The code includes the following:

code for receiving input representing that a site visit has been completed and an identifier of a report type for a site visit report;

code for determining, by a computing device, at least one deadline for completing the site visit report for the site visit based on a completion date of the site visit and output a notification to an associate about the deadline;

code for determining, by the computing device, at least one question of a plurality of questions that is associated with the identifier and configure a user interface to include the at least one question; and

code for, in response to receiving an approval of the site visit report, providing the site visit report.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings, where:

FIG. 1 is a block diagram of a system for managing site visit reports according to one embodiment;

FIG. 2 is a flow chart of a method for managing site visit reports according to one embodiment;

FIG. 3 is a flow chart of a method for configuring a user interface to include questions and to receive answers according to one embodiment;

FIG. 4 is a flow chart of a method for finalizing a site visit report based on received answers according to one embodiment;

FIG. 5 is a user interface with which an associate can begin scheduling a site visit via a site visit tab according to one embodiment;

FIG. 6 is a user interface with which an associate can schedule a site visit according to one embodiment;

FIG. 7 is a user interface with which an associate can mark that a scheduled site visit has been completed according to one embodiment;

FIG. 8 is a user interface with which notifications can be provided to an associate according to one embodiment;

FIG. 9 is a user interface on which an associate can select a site visit for which to complete a site visit report according to one embodiment;

FIG. 10 is a user interface on which questions can be provided to an associate and answers can be received from the associate according to one embodiment;

FIG. 11 is a user interface on which questions are provided based on answers to previous questions according to one embodiment; and

FIG. 12 is a user interface on which questions in a tab are provided based on answers to questions in other tabs according to one embodiment.

### DETAILED DESCRIPTION

Certain features of the present disclosure include systems and methods for managing site visit reports, including more efficient facilitation of site visit report creation, tracking, approval processing, and organization. “Site visit report” as used herein includes data regarding a visit by an associate to a site participating in (or that may participate in) a clinical trial and includes, alone or in combination, a site visit report, site visit report addendum, contact report, follow-up letter, and collateral material. An “associate” as used herein is personnel that is associated (e.g. an employee or contractor) with the clinical research organization, sponsor, or other clinical trial managing entity for a clinical trial and can include a clinical research associate (CRA).

Certain embodiments can utilize data relationships in a database system and process flow rules to (i) output reminder messages regarding deadlines associated with a site visit; (ii) determine and present proper questions to associates to elicit relevant information about a site visit; (iii) allow associates to electronically sign a site visit report; (iv) associate relevant documents to site visit reports; and (v) organize site visit reports by linking to the site visit reports from the document management system.

In one example, a system implementing certain features of the present disclosure outputs a user interface to an associate to receive an input regarding a planned site visit. The system can access a database system to determine a manager that is associated with the site and can provide a notice to the manager to request approval of the site visit. After receiving approval of the site visit, the system can receive from the associate scheduling information for the site visit and an identifier that represents the type of site visit report to be completed. In accordance with stored process rules, the system can automatically output based on the scheduled site visit date a reminder to the associate to complete a site visit report by one or more deadlines specified in the stored process rules.

The system can determine the questions to present to the associate via a user interface based on the identifier of the type of site visit report. For example, the system can present relevant questions to the associate based on the type of site visit report that the associate is creating and can prevent other, irrelevant questions from being presented to the associate (or it can otherwise gray out fields on the user interface to prevent the associate from inputting answers to irrelevant questions). The system may also present subsequent questions to the associate based on answers to one or more initial questions. For example, the system can analyze an answer to a first question, determine based on the analysis that additional information is needed, and output a second question that seeks the additional information that the system determined. The second question may be presented contemporaneously with the first question or it can be designated as an action item and the system can periodically output reminders to the associate to provide the additional information.

The system can receive an input from an associate that a site visit report is complete. In response, the system can analyze the site visit report with respect to process rules for the clinical trial to confirm that the site visit report is complete in that it includes the information specified by the applicable process rule(s). If the site visit report is incomplete, a notification regarding the omission can be sent to the associate. If the site visit report is complete, the system can receive an electronic signature of the associate and transmit a notification to a reviewer that a completed site visit report is available for review.

The system can facilitate communication between reviewer and associate by presenting to the associate follow-up questions received from the reviewer, associating answers received from the associate with the site visit report, and providing the answers to the reviewer. After receiving approval of the site visit report from the reviewer and an electronic signature of the reviewer, the system can provide the site visit report to a sponsor and to a document management system for finalization and storage. Finalizing a site visit report can include creating an electronic file, such as a portable document file, of the site visit report and including associated documents, such as collateral documents, (if applicable) in the electronic file. The sponsor can review the site visit report.

Features of certain exemplary implementations of the innovations disclosed herein include automated electronic file (e.g. PDF) generation of site visit reports, automated storage of site visit reports in a document management system, automated emailing of site visit reports on approval, and the capability of adding collateral documents to the site visit reports.

These illustrative examples are given to introduce the reader to the general subject matter discussed here and are not intended to limit the scope of the disclosed concepts. The following sections describe various additional embodiments and examples with reference to the drawings in which like numerals indicate like elements.

### Illustrative System Implementation

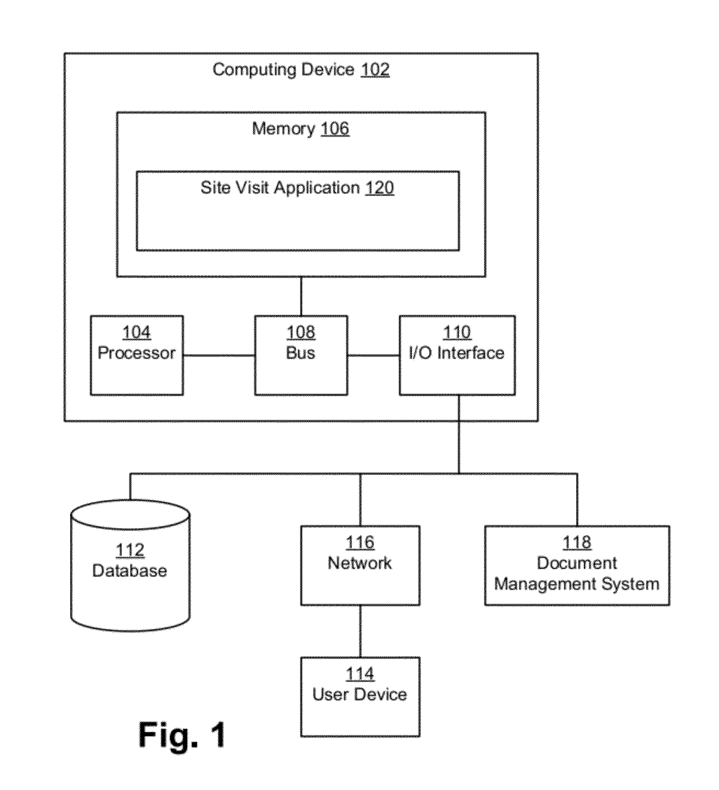

FIG. 1 depicts a system that is capable of managing clinical trial site visit report creation, tracking, storage, and approval according to certain embodiments. Other embodiments may be utilized. The system includes a computing device 102 having a processor 104 that can execute code stored on a computer-readable medium, such as a memory 106, to cause the computing device 102 to manage clinical trial site visit reports. The computing device 102 may be any device that can process data and execute code that is a set of instructions to perform actions. Examples of the computing device 102 include a database server, a web server, desktop personal computer, a laptop personal computer, a server device, a handheld computing device, and a mobile device.

Examples of the processor 104 include a microprocessor, an application-specific integrated circuit (ASIC), a state machine, or other suitable processor. The processor 104 may include one processor or any number of processors. The processor 104 can access code stored in the memory 106 via a bus 108. The memory 106 may be any non-transitory computer-readable medium capable of tangibly embodying code. The memory 106 can include electronic, magnetic, or optical devices, capable of providing processor 104 with executable code. Examples of the memory 106 include random access memory (RAM), read-only memory (ROM), a floppy disk, compact disc, digital video device, magnetic disk, an ASIC, a configured processor, or other storage device. The bus 108 may be any device capable of transferring data between components of the computing device 102. The bus 108 can include one device or multiple devices.

The computing device 102 can share data with additional components through an input/output (I/O) interface 110. The I/O interface 110 can include a USB port, an Ethernet port, a serial bus interface, a parallel bus interface, a wireless connection interface, or any suitable interface capable of allowing data transfers between the computing device and another component. The additional components can include a database 112, a user device 114 over a network 116, a document management system 118. In other embodiments, the computing device 102 includes the database 112 and/or the document management system 118. The computing device 102 may in some embodiments communicate with the database 112 and/or the document management system 118 over network 116.

The database 112 may be a customer relationship management (CRM) database, such as a Siebel CRM database available from Oracle Corp. of Redwood Shores, Calif. The user device 114 can include a second computing device, such as a laptop or personal computer that is capable of processing commands to output a user interface to a display. The network 116 can include the internet, an intranet, wide area network (WAN), local area network (LAN), virtual private network (VPN), or any suitable communications network that allows computing device 102 to communicate with other components.

Instructions can be stored in the memory 106 as executable code. The instructions can include processor-specific instructions generated by a compiler and/or an interpreter from code written in any suitable computer-programming language, such as C, C++, C#, Visual Basic, Java, Python, Perl, JavaScript, and ActionScript. The instructions can include a site visit application 120 that, when executed by the processor 104, can cause the computing device 102 to manage clinical trial site visit reports as explained in more detail below.

This exemplary system configuration is provided merely to illustrate potential configurations that can be used to implement certain embodiments. Other configurations may of course be utilized.

### Exemplary Methods of Managing Site Visit Report Generation

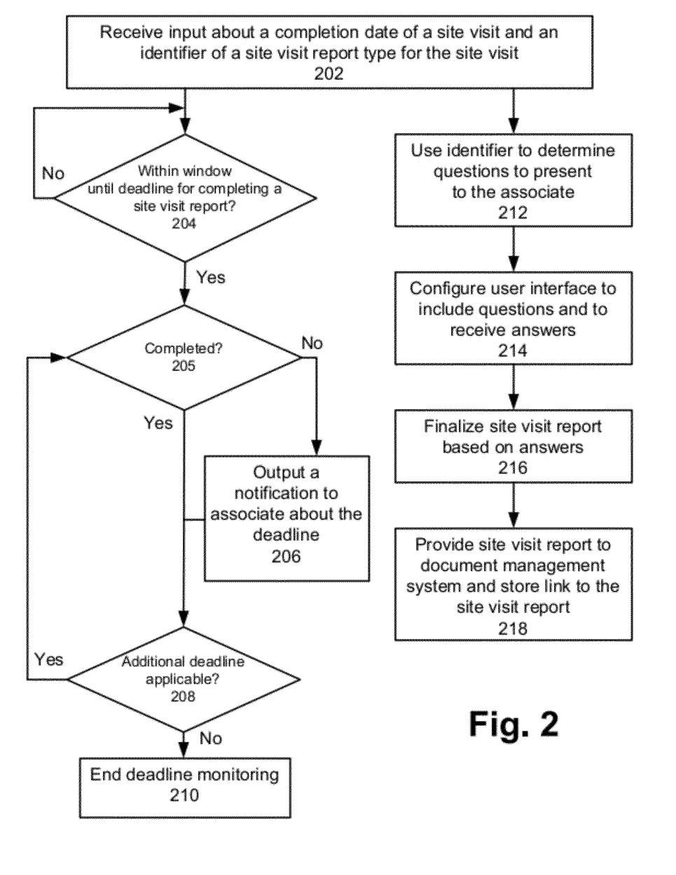

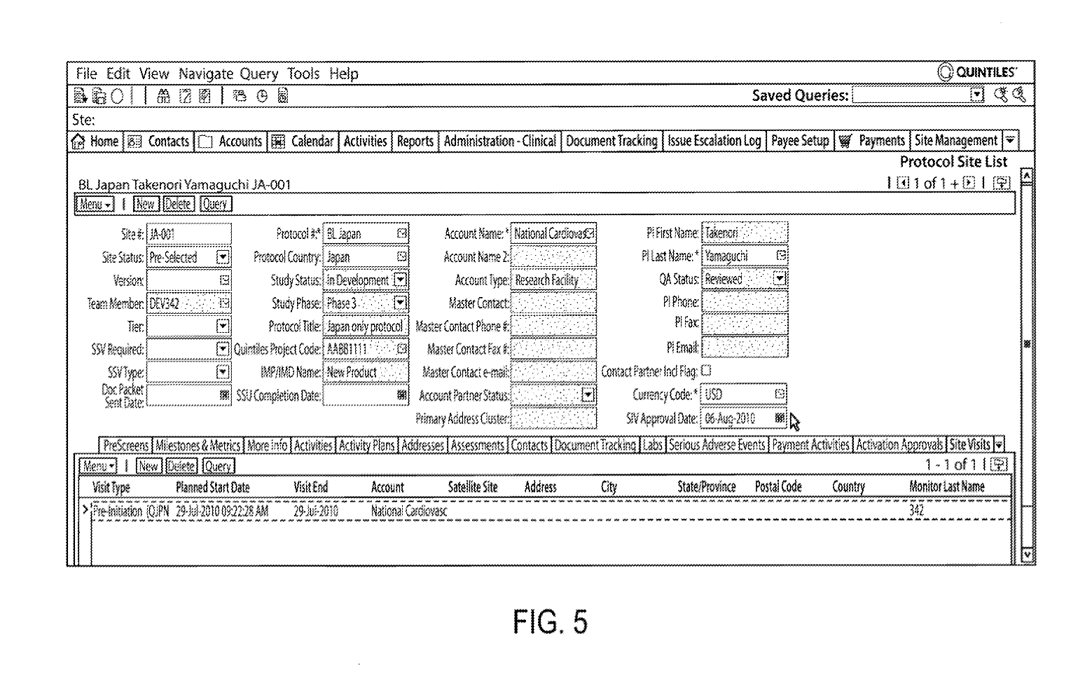

FIGS. 2-4 are flow diagrams that depict processes for managing site visit reports, in particular creating site visit reports, according to certain embodiments of the present invention. The processes are described with reference to the system implementation shown in FIG. 1 and user interfaces shown in FIGS. 5-12. Other system and user interface implementations, however, are possible.

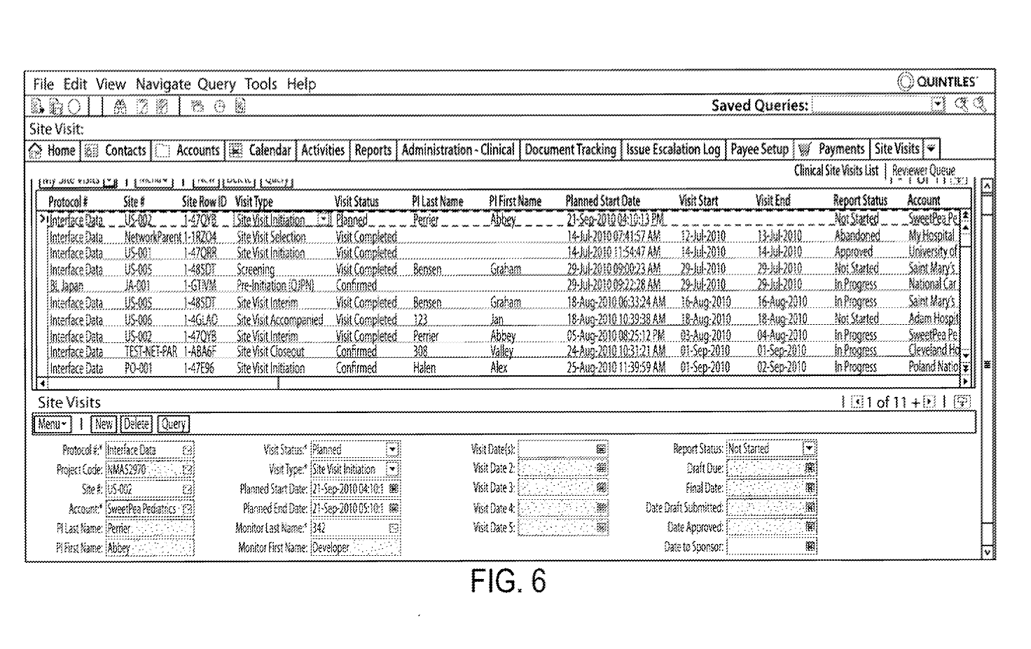

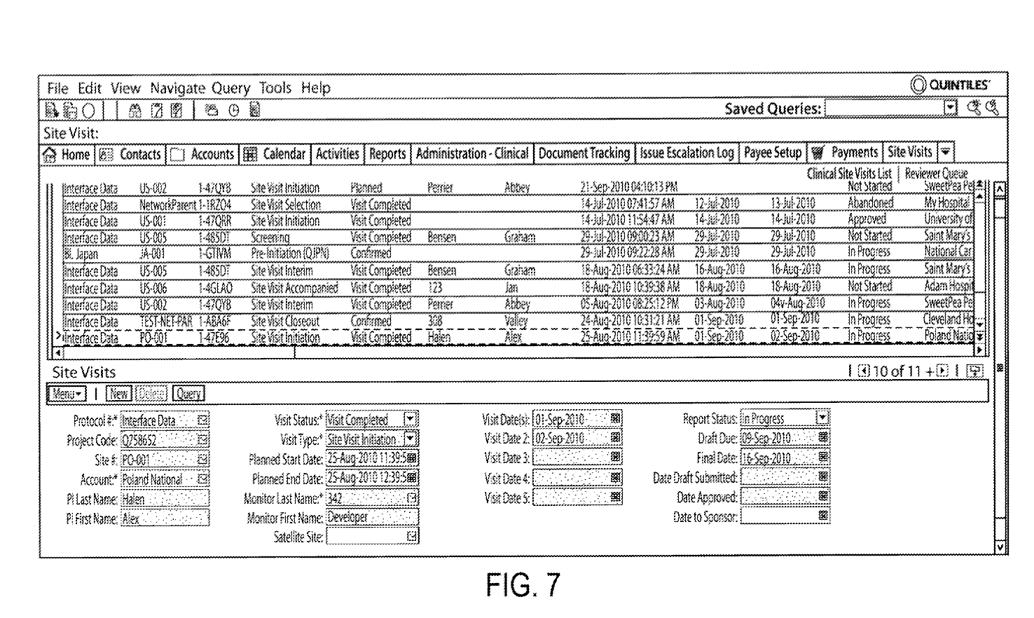

FIG. 2 is an overall process for creating a site visit report. In block 202, the computing device 102 receives an input about a completion date of a site visit and an identifier of a type of site visit report for the site visit. The input and identifier can be received from the user device 114 as information fields in a web page presented by the computing device 102 to the user device 114. FIG. 5, for example, depicts a user interface that allows an associate or other approved personnel to access a “Site Visits” tab and begin scheduling a site visit. FIG. 6 depicts a user interface with which an associate can input an identifier for a visit type for a site visit (e.g. “Site Visit Initiation”). Examples of identifiers for types of site visit reports include site selection visit (SSV), site initiation visit (SIV), site monitoring visit (SMV), and site closeout visit (COV). Other types of site visits include pre-initiation visit, pharmacy visit, training/booster visit, site visit query, telephone selection, telephone initiation, telephone interim, telephone closeout, telephone query, telephone readiness check, and telephone training/booster. These types of site visits may be associated to a specified type of site visit report. The user interface can be used also to input site visit date(s), that populate the “Visit Start” date and a “Visit End” date fields. After completing the site visit, the associate can use a user interface, such as the user interface in FIG. 7 to input a “Visit Completed” designation in the “Visit Status” field.

Returning to FIG. 2, after receiving the input about the site visit completion date and the identifier of the site visit report type, the computing device 102 can perform various processes in accordance with configured workflow rules and requests received from the user device 114. In block 204, for example, the computing device 102 determines whether the current date and time as compared to a deadline for completing a site visit report is within a pre-set window. The pre-set window may be configured by a system administrator or otherwise associated with a workflow rule. A deadline for completing the site visit report can include five working days after completing a site visit for a draft of the site visit report to be completed and submitted, and ten working days after completing the site visit for a final version of the site visit report to be completed and approved. An example of a window is one or two days. If it is not within the window, the system repeats its monitoring until it is within the window or the site visit report is completed. In some embodiments, the computing device 102 can be configured to monitor for deadlines that have past without action and to output a notification to an associate after identifying a deadline that has past without receiving an indication that the associate as taken the expected or required action.

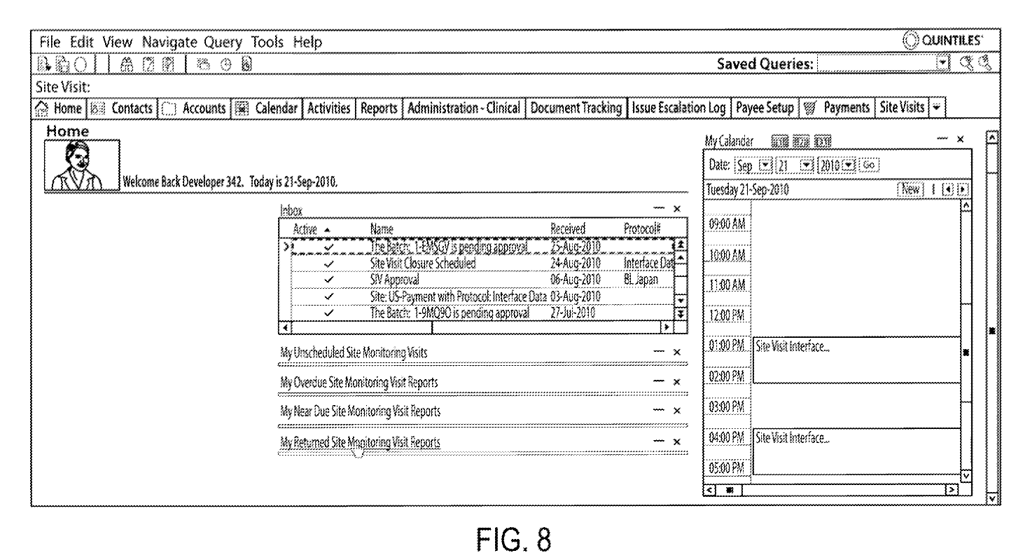

If it is within the window, the computing device 102 can determine if the site visit report is completed in block 205, such as by accessing database 112, document management system 118, or memory 106. If the computing device 102 determines that the site visit report is not completed, the computing device 102 can output a notification about the deadline to the associate associated with the site visit report in block 206. In some embodiments, the computing device 102 periodically outputs a notification until the computing device receives confirmation that the site visit report or other triggering event has been completed. The notification may be an e-mail message transmitted to an e-mail address. In some embodiments, the notification is a message transmitted to an account for the associate provided by the site visit application 120 and available upon sign-in by the associate to the system. FIG. 8 depicts an example of a user interface for an associate that includes various notifications in an inbox. The inbox can be further organized into various groups, including unscheduled site monitoring visits, overdue site monitoring visit reports, near due site monitoring visit reports, and returned site monitoring visit reports.

Returning to FIG. 2, after outputting the notification or if the computing device 102 determines that the site visit report is completed in block 205, the computing device 102 determines in block 208 whether any additional deadline is applicable to the site visit report. Examples of deadlines that may be applicable include providing an answer to a request for additional information received from a reviewer or determined by the computing device 102. If the computing device 102 determines an additional deadline is applicable, the computing device 102 determines whether the task, event, or other topic that is the subject of that deadline has been completed in block 205 and, if not, can output a notification to the associated associate, or other appropriate personnel, as in block 206. If the computing device 102 determines that no additional deadline is applicable to the site visit report, deadline monitoring and tracking ends in block 210.

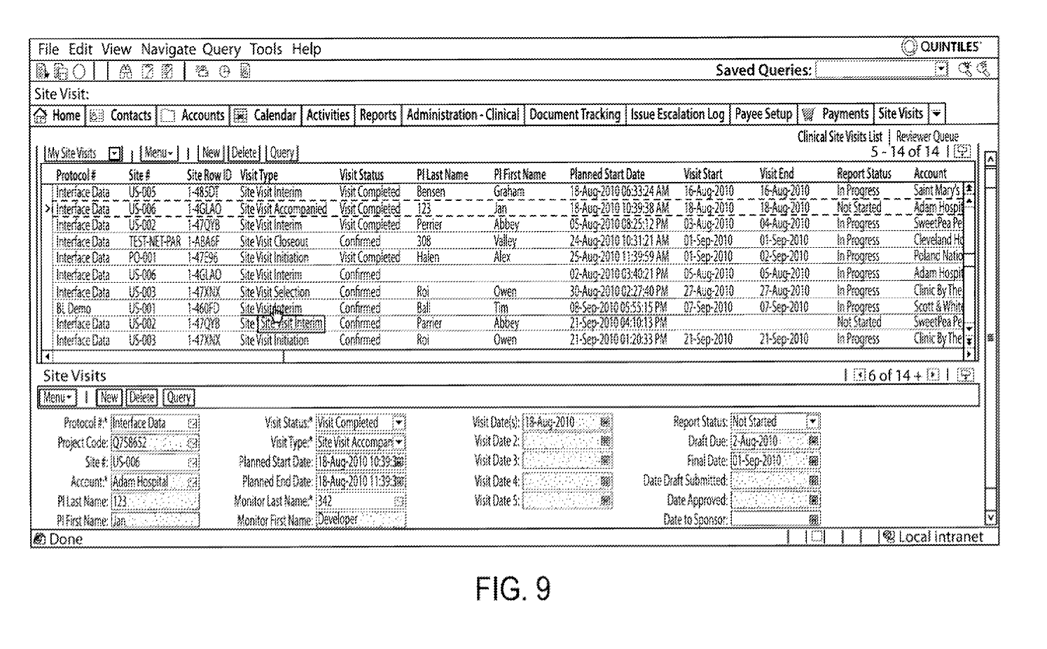

In addition to tracking deadlines, the computing device 102 can be configured to otherwise facilitate site visit report generation. In block 212, the computing device 102 accesses the database 112 using the identifier to determine one or more questions to present to the associate. For example, FIG. 9 depicts a user interface with which an associate can select a site visit for which to complete a site visit report. The site visit is associated with an identifier of the type of site visit report to be completed for the site visit.

The database 112 can include various identifiers. Each identifier corresponds to a type of site visit report, and can include a set of questions. Each question can be associated to one or more identifiers such that each identifier is associated with a subset of questions. That is, a question can be associated with more than one identifier and an identifier can be associated with some of questions from the set of questions. The computing device 102 can select the subset of questions that is associated with the identifier of the site visit report type, from the selection for example of a site visit via a user interface as in FIG. 9.

Returning to FIG. 2, in block 216, the computing device 102 configures a user interface to include the subset of questions associated with the identifier and to be able to receive answers to the subset of questions. The user interface may be a web page generated by the computing device 102 dynamically (e.g. “on the fly”) to include one or more of the subset of questions. In some embodiments, the computing device 102 configures the user interface to include tabs, each of which have a group of questions from the subset of questions, where the group of questions relate to a particular topic. Answers can be received for example through inputs to fields associated with the subset of questions displayed on the user interface.

Answers to the questions can be used by the computing device 102 to generate the site visit report as in block 216. In some embodiments, a completed site visit report is submitted to a reviewer that can reject or approve the site visit report. If the reviewer rejects the site visit report, it may be returned to the associate for completion of one or more items identified or requested by the reviewer. If the reviewer approves the site visit report, it can be deemed completed. The completed site visit report may include an electronic signature from the associate and an electronic signature from the reviewer.

The computing device 102 can provide the site visit report to the document management system 118 and store a link to the site visit report, in block 218. For example, the document management system 118 can be configured to store an electronic representation of the site visit report in an organized data store. The link can provide quick access at a later time to the site visit report using the site visit application 120. In some embodiments, the document management system 118 is configured to periodically review the contents of the computing device 102 and automatically determine that a newly completed site visit report is present. The document management system 118 can obtain the completed site visit report and replace it with a link to the location in the document management system 118 at which the site visit report is stored.

In some embodiments, a site visit report is provided to a reviewer that reviews the site visit report and must approve it prior to it being stored in the document management system. The computing device 102 can be configured to transmit, such as via e-mail, automatically an approved site visit report to a sponsor. In some embodiments, the computing device 102 provides a link to the sponsor with which the sponsor can access the site visit report.

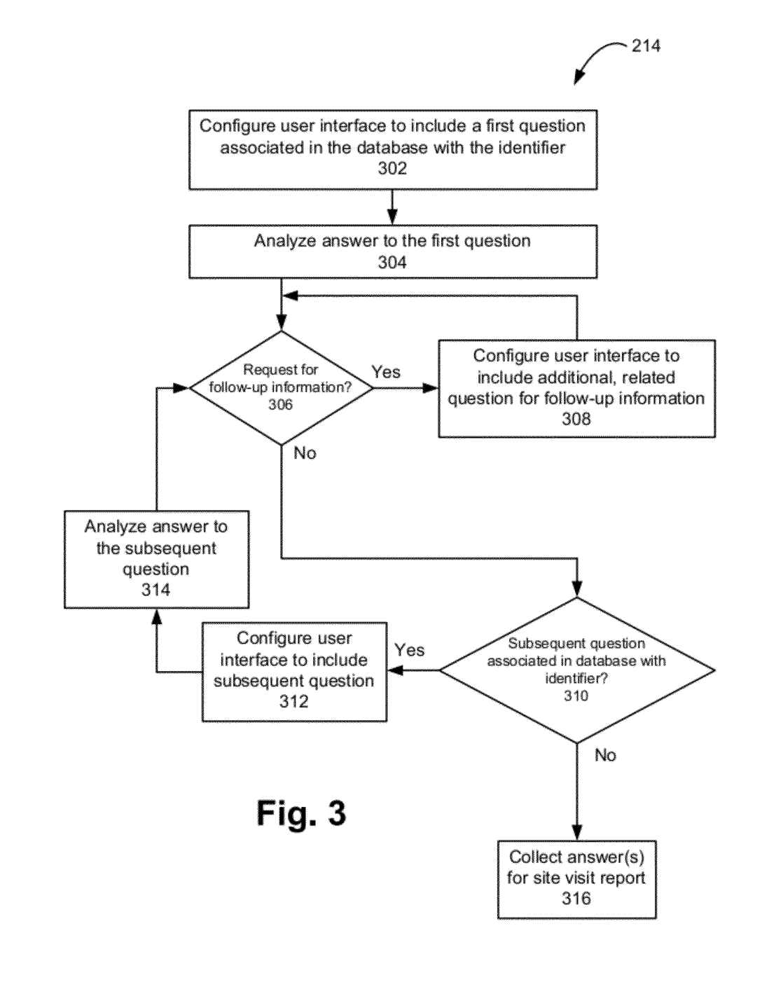

Various processes can be used to configure a user interface to include questions for the associate and to receive answers to the questions as in block 214 of FIG. 2. FIG. 3 depicts one example of a process flow for configuring the user interface.

In block 302, the computing device configures a user interface to include a first question that is associated in the database 112 with the identifier of the site visit report being completed. The user interface may be capable of being displayed in a web browser of the user device 114 operated by the associate. The first question may be specified in the database 112 as the first question of the subset of questions to be presented to the associate. In some embodiments, the first question is the first question of a group of questions of the subset of questions, where the group of questions is associated with a tab on the user interface. The user interface can be configured to receive an answer to the first question via a field capable of receiving input from the associate, or otherwise.

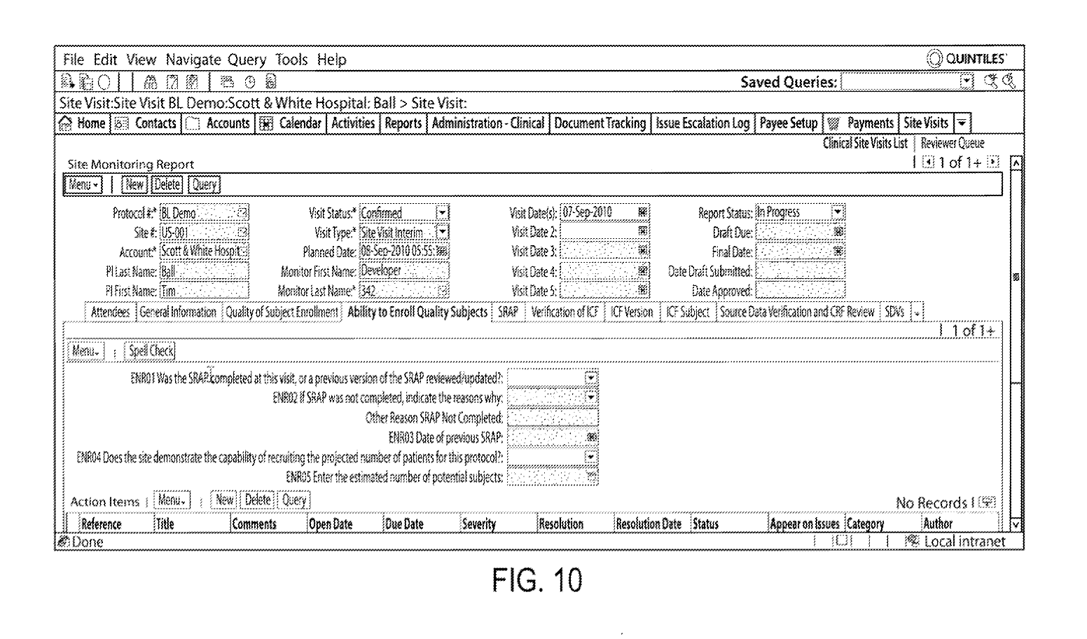

FIG. 10 depicts an example of a user interface that includes a first question of “Was the SRAP completed at this visit, or a previous version of the SRAP reviewed/updated?” and an associated field to allow the associate to input an answer via a drop-down menu with potential answers. SRAP is an acronym for “site recruitment action plan.” The question is presented under the tab labeled “Ability to Enroll Quality Subjects.” Other fields for other questions may be configured differently to allow an associate to input an answer. For example, a field may not include a drop-down menu and instead allows an associate to enter explanatory text to answer a question. Furthermore, irrelevant questions, or questions not yet deemed relevant, may be grayed out to prevent the associate from focusing on those questions.

Returning to FIG. 3, in block 304, the computing device 102 analyzes the answer to the first question. For example, the computing device 102 can compare the answer to an expected answer based on information previously received about the site or information about common answers to the question.

In block 306, the computing device 102 can determine whether, based on the analysis, the computing device 102 should request that the associate provide follow-up information about the topic of the first question. If the computing device 102 determines that it should request follow-up information, the computing device configures the user interface to receive follow-up information via one or more additional, related questions in block 308. The follow-up information can be analyzed by the computing device 102 and the computing device 102 can again determine whether any additional requests for follow-up information are needed in block 306.

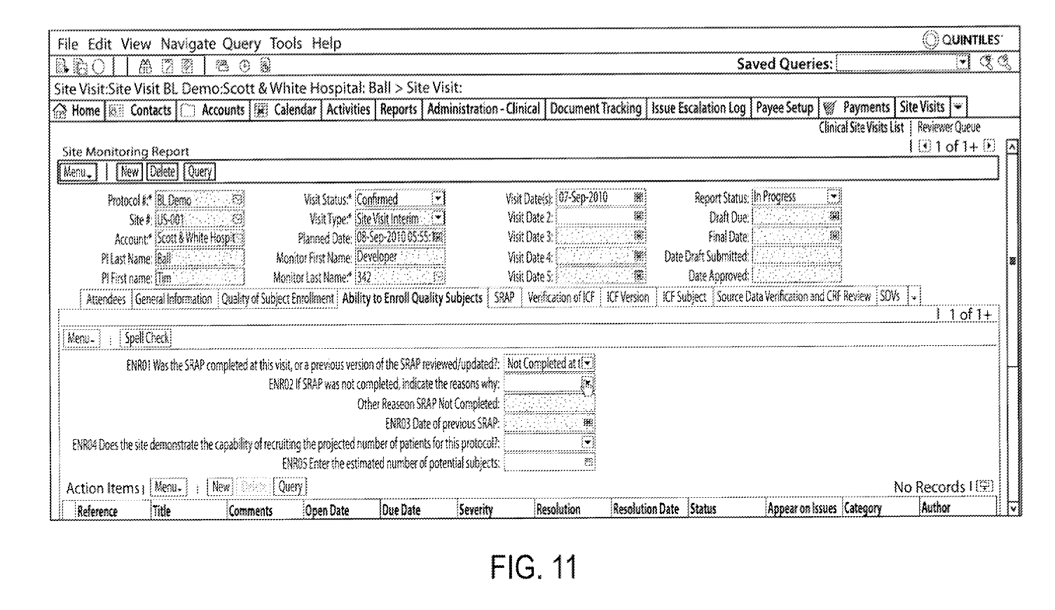

FIG. 11 depicts an example user interface that presents follow-up questions to an associate based on an answer to the first question. In response to an answer (“Not completed at this visit”) to the first question (“Was the SRAP completed at the visit, or a previous version of the SRAP reviewed/updated?”), fields for additional questions are available for an associate to input answers to additional questions that seek follow-up information (“Does the site demonstrate the capability of recruiting the projected number of patients for this protocol?” and “Enter the estimated number of potential subjects.”).

Returning to FIG. 3, if the computing device 102 determines that it does not need to request for follow-up information, the computing device 102 can determine whether a subsequent question is associated in the database 112 with the identifier of the site visit report type, in block 310. For example, the computing device 102 can determine whether another question in the subset of questions is to be presented to the associate via a user interface so that the computing device 102 can receive an answer for the subsequent question.

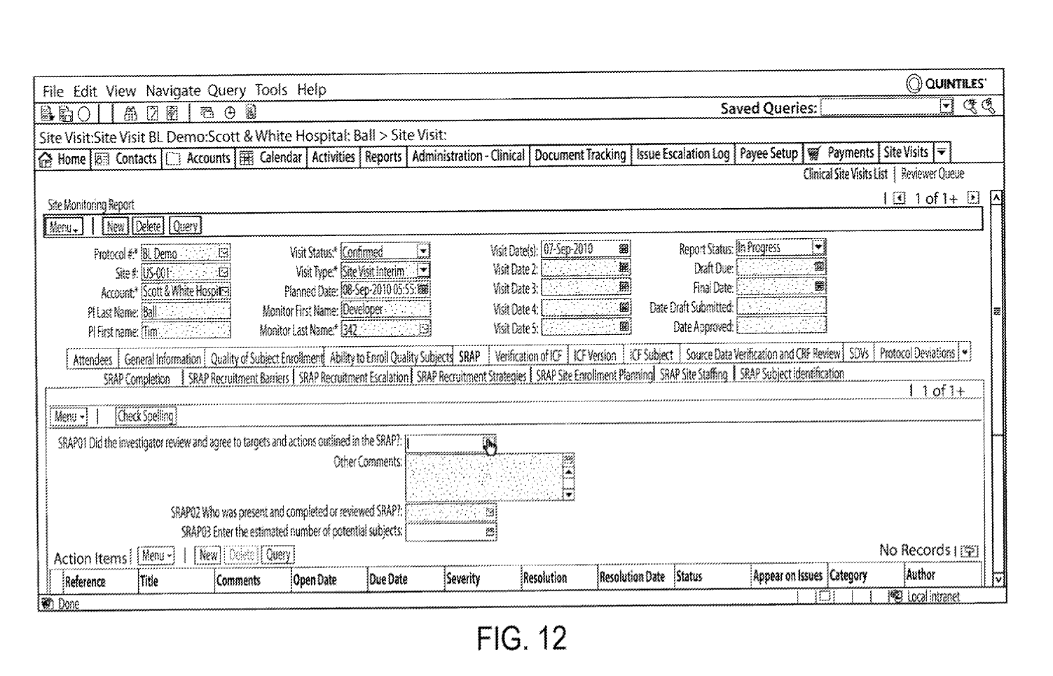

If the computing device 102 determines that a subsequent question is associated with the identifier, the computing device 102 can configure the user interface to include the subsequent question in block 312. For example, an answer to a question in one tab can affect the questions that are presented in other tabs. FIG. 12 depicts a user interface in which the questions presented for answers from associates under the “SRAP” tab are based on the answers to questions in the “Ability to Enroll Quality Subjects” tab.

Returning to FIG. 3, in block 314, the computing device 102 analyzes the answer to the subsequent question and the process can return to block 306 to determine whether a request for follow-up information is needed based on the analysis in block 314.

If the computing device 102 determines that no subsequent question is associated with the identifier, the answers received to the questions presented to the associate are collected for the site visit report in block 316.

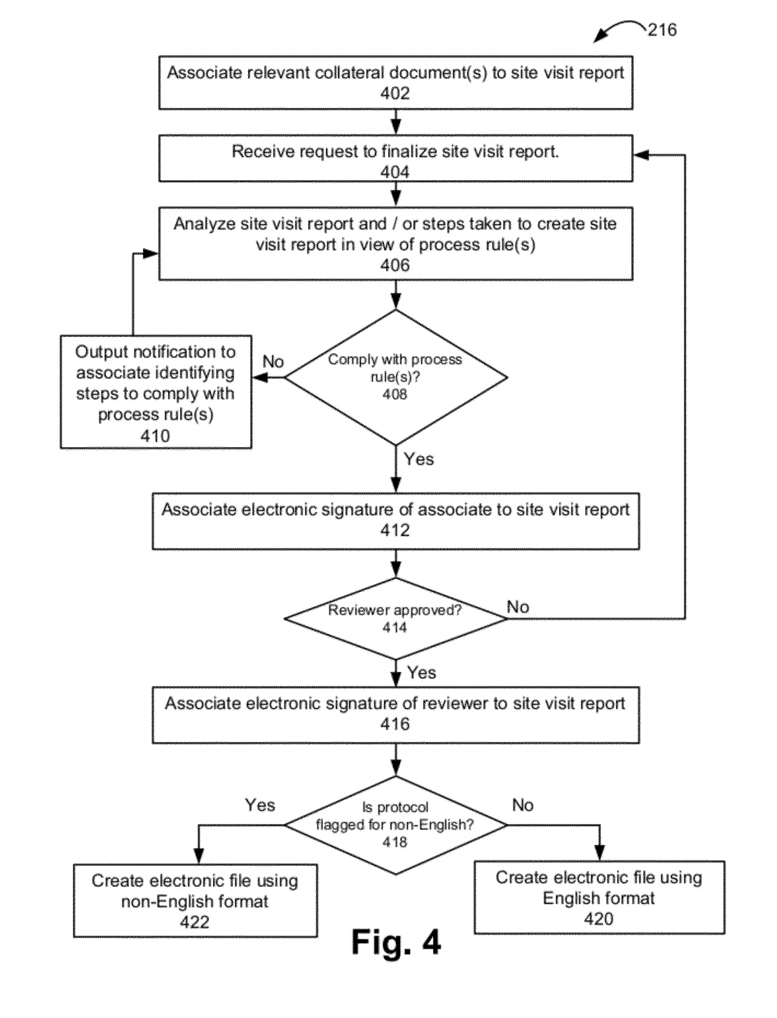

Various processes can be used to finalize site visit reports based on answers as in block 216 of FIG. 2. FIG. 4 depicts one example of a process flow for finalizing a site visit report.

In block 402, the computing device 102 associates any relevant collateral documents to the site visit report. Collateral documents can include any document that is relevant to the site visit report, such as by being referenced in the site visit report or by providing support for one or more answers in the site visit report. A collateral document can be associated to the site visit report by linking the collateral document to the site visit report in a database, such as database 112, or by attaching the collateral document to the site visit report.

In block 404, the computing device 102 receives a request to finalize the site visit report. The request can be received from the associate via a user interface and can be accompanied by a request to submit the site visit report to a reviewer for approval. In response to receiving the request, the computing device 102 in block 406 can analyze the site visit report and/or steps taken to create the site visit report, in view of process rules associated with the identifier of the site visit report type in database 112. For example, the computing device 102 uses the identifier to determine one or more process rules that are associated with the identifier. A process rule can include procedural or substantive requirements that must be met by the site visit report prior to it being submitted to the reviewer or otherwise finalized. Process rules can be based on a clinical trial protocol or otherwise. In some embodiments, no process rules are applicable and the computing device 102 can continue without performing these “process rule” steps.

In block 408, the computing device 102, based on the analysis, determines whether the site visit report complies with any associated process rules. If the computing device 102 determines that the site visit report does not comply with the associated process rules, the computing device 102 outputs a notification to the associate that identifies steps that are needed to comply with the process rules in block 410. The steps may be additional information to include in the site visit report or a procedural issue for the associate to complete.

If the computing device 102 determines that the site visit report complies with applicable process rules, the computing device 102 associates an electronic signature received from the associate to the site visit report in block 412. The electronic signature may be a unique signature associated with the associate and can provide a layer of security to prevent unauthorized personnel from submitting or otherwise completing a site visit report. The site visit report can be provided to a reviewer for analysis.

In block 414, the computing device 102 determines whether the reviewer approved the site visit report. For example, the computing device 102 can receive a response from the reviewer that specifies the site visit report is approved or a response that the site visit report is not approved, and optionally reasons for not approving the site visit report. If the site visit report is not approved, the computing device 102 can transmit the site visit report to the associate for completing the items identified by the reviewer. If the site visit report is approved, the computing device 102 can associate an electronic signature of the reviewer to the site visit report in block 416.

In block 418, the computing device 102 determines if the protocol associated with the site visit report is flagged for non-English formatting. For example, a protocol can be flagged for Japanese electronic file formatting. If the protocol is not flagged, the computing device 102 creates an electronic file, such as a PDF, using an English format in block 420. If the protocol is flagged, the computing device 102 creates an electronic file, such as a PDF, using a non-English format, such as a Japanese format, in block 422. The electronic file can include the answers to the questions, administrative-type information about the site, associate, and site visit (e.g. scheduling, location, etc.), and collateral documents, among other types of items that can be included in an electronic file of the site visit report, including the electronic signature blocks having electronic signatures of the associate and reviewer.

Although various processes have been described as being performed by the computing device 102, processing may be completed by other system devices. For example, the database 112, document management system 118, and user device 114 may perform one or more process steps described and communicate results of the processing to the computing device 102, or these additional components can otherwise assist the computing device 102 in completing one or more of the process steps.

Furthermore, site visit reports according to various embodiments can be associated with an audit trail that can be tracked, managed, and updated by one or more of the computing device 102, the database 112, the document management system 118, and the user device 114. The audit trail may be required by a regulatory agency or otherwise.

### General

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed is:

1. A clinical trial site visit management system comprising:
a database comprising a plurality of questions associated with identifiers of report types for site visits that are conducted to manage clinical trials; and
a processor capable of executing code embodied on a non-transitory computer-readable medium to cause the clinical trial site visit management system to:
responsive to receiving input representing that a site visit has been completed, determine at least one deadline for completing a site visit report for the site visit;
output a notification to an associate regarding the at least one deadline;
responsive to receiving an identifier of a report type for the site visit report, determine at least one question of the plurality of questions that is associated with the identifier and configure a user interface to include the at least one question; and
responsive to receiving an approval for the site visit report, provide the site visit report to a document management system.

2. The clinical trial site visit management system of claim 1, wherein the processor is further configured to store a link to the site visit report that is in the document management system.

3. The clinical trial site visit management system of claim 1, wherein the processor is further configured to associate at least one document with the site visit report.

4. The clinical trial site visit management system of claim 1, wherein the site visit report comprises electronic signatures of the associate and a reviewer.

5. The clinical trial site visit management system of claim 1, wherein the processor is further configured to, responsive to receiving a specified response to the at least one question, configure the user interface to prohibit receiving a response to a subsequent question to the at least one question.

6. The clinical trial site visit management system of claim 1, wherein the database comprises process rules associated the identifiers of report types for site visits.

7. The clinical trial site visit management system of claim 6, wherein the processor is further configured to, responsive to receiving a command to submit the site visit report to a reviewer, confirm that at least one of (i) the site visit report or (ii) steps for completing the site visit report, comply with a process rule associated with the identifier of the report type for the site visit report.

8. The clinical trial site visit management system of claim 1, wherein the processor is further configured to:
analyze a response to the at least one question to determine additional information is desirable; and
generate at least one additional question based on the response to seek the additional information.

9. The clinical trial site visit management system of claim 1, wherein the processor is further configured to generate an audit trail for the site visit report.

10. The clinical trial site visit management system of claim 1, wherein the processor is further configured to output a message to a sponsor of a clinical trial associated with the site visit, the message comprising the site visit report.

11. The clinical trial site visit management system of claim 1, wherein the processor is further configured to receive a schedule for the site visit prior to the site visit occurring and to output a message to the associate after the site visit was scheduled to occur, the message comprising a reminder for the associate to complete the site visit report.

12. The clinical trial site visit management system of claim 1, wherein, responsive to receiving the approval for the site visit report from a reviewer, the processor is further configured to:
create a portable document file (PDF) of the site visit report using a Japanese format template if a protocol associated with the site visit report is flagged; and
create the PDF of the site visit report using an English format template if the protocol associated with the site visit report is unflagged.

13. The clinical trial site visit management system of claim 1, wherein the processor is further configured to receive additional questions from a reviewer and configure the user interface to present the additional questions to the associate.

14. The clinical trial site visit management system of claim 1, wherein the database comprises a Siebel customer relationship management (CRM) database,
wherein the processor comprises a database server software application.

15. The clinical trial site visit management system of claim 1, wherein the at least one deadline comprises a first deadline for completing a draft of the site visit report and a second deadline for completing a final version of the site visit report.

16. The clinical trial site visit management system of claim 1, wherein the report types comprise:
a site selection visit (SSV) report;
a site initiation visit (SIV) report;
a site monitoring visit (SMV) report; and
a site closeout visit (COV) report.

17. The clinical trial site visit management system of claim 1, further comprising the document management system, the document management system being capable of creating a file comprising the site visit report and at least one document associated with the site visit report.

18. The clinical trial site visit management system of claim 17, where the database comprises the document management system.

19. A computer-implemented method for managing a clinical trial, comprising:
receiving input representing that a site visit has been completed and an identifier of a report type for a site visit report about the site visit;
determining, by a computing device, at least one deadline for completing the site visit report based on a completion date of the site visit and outputting a notification to an associate about the at least one deadline;
determining, by the computing device, at least one question of a plurality of questions that is associated with the identifier and configuring a user interface to include the at least one question; and
in response to receiving an approval of the site visit report, providing the site visit report to a sponsor.

20. The computer-implemented method of claim 19, further comprising:
in response to receiving the approval of the site visit report,
creating a portable document file (PDF) comprising the site visit report and a collateral document;
providing the PDF file to a document management system for storage; and
storing a link to the PDF file stored in the document management system.

21. The computer-implemented method of claim 19, further comprising:
analyzing an answer to the at least one question and determining a subsequent question to present on the user interface based on the answer; and
confirming that at least one of (i) the site visit report or (ii) steps for completing the site visit report, comply with a process rule associated with the identifier of the report type for the site visit report.

22. The computer-implemented method of claim 19, wherein outputting the notification to the associate about the at least one deadline comprises outputting the notification after determining a task associated with the deadline has not been completed.

23. A non-transitory computer-readable medium tangibly embodying executable code for managing a clinical trial, the code comprising:
code for receiving input representing that a site visit has been completed and an identifier of a report type for a site visit report;
code for determining, by a computing device, at least one deadline for completing the site visit report for the site visit based on a completion date of the site visit and output a notification to an associate about the at least one deadline;
code for determining, by the computing device, at least one question of a plurality of questions that is associated with the identifier and configure a user interface to include the at least one question; and
code for, in response to receiving an approval of the site visit report, outputting the site visit report.
